(19) United States
(12) Patent Application Publication
(10) Pub. No.: US 2007/0040766 A1
(43) Pub. Date: Feb. 22, 2007

(54) Plasma display panel power recovery method and apparatus

(76) Inventor: Dong-Myung Lee, Yongin-si (KR)

Correspondence Address: CHRISTIE, PARKER & HALE, LLP, PO BOX 7068, PASADENA, CA, 91109-7068, US

(21) Appl. No.: 11/504,261

(22) Filed: Aug. 14, 2006

(30) Foreign Application Priority Data
Aug. 17, 2005 (KR) 10-2005-0075166

(51) Int. Cl. G09G 3/28

(52) U.S. Cl. 345/66

(57) ABSTRACT

In the plasma display device, a voltage of a power recovery capacitor is set to be greater than half of a sustain discharge voltage when a voltage of a power recovery circuit is increased, and is set to be lower than half of the sustain discharge voltage when the voltage of the power recovery circuit is decreased. Accordingly, power recovery efficiency can be improved.

### CROSS-REFERENCE TO RELATED APPLICATION

This application claims priority to and the benefit of Korean Patent Application No. 10-2005-0075166 filed in the Korean Intellectual Property Office on Aug. 17, 2005, the entire content of which is incorporated herein by reference.

### BACKGROUND

The present invention relates to a plasma display device and a driving method thereof. More particularly, the present invention relates to a power recovery circuit of a plasma display device.

A plasma display. device is a flat panel display that uses plasma generated by a gas discharge to display characters or images. It includes a plasma display panel (PDP) wherein tens to millions of pixels are provided in a matrix format, depending on its size.

When one PDP electrode is applied with a sustain discharge pulse and another electrode operates as a capacitive load additional reactive power is needed as well as power for a sustain discharge in order to apply a sustain pulse to the two electrodes. A sustain discharge circuit therefore typically includes a power recovery circuit for recovering and reusing the reactive power.

However, it becomes extremely difficult for a conventional power recovery circuit to recover 100% of energy because a switch and the circuit may cause losses while recovering power, and accordingly a sustain discharge voltage cannot be increased to a high level voltage of the sustain discharge pulse or cannot be decreased to a low level voltage of the same during a power recovery operation. When the switch that supplies the high level voltage or the low level voltage of the sustain discharge pulse is turned on in this state, the switch may be hard-switched thereby causing damage to the switch as well as causing electromagnetic interference (EMI). Therefore, a need exists for the reduction of switching loss in a power recovery circuit.

### SUMMARY OF THE INVENTION

In accordance with the present invention, the power recovery efficiency of a power recovery circuit coupled to sustain discharge electrodes of a plasma display panel is improved. A voltage of a first power recovery capacitor in the power recovery circuit is set to be greater than half of a sustain discharge voltage when a voltage of the power recovery circuit applied to the sustain discharge electrodes is increased, and a voltage of a second power recovery capacitor in the power recovery circuit is set to be lower than half of the sustain discharge voltage when the voltage of the power recovery circuit applied to the sustain discharge electrodes is decreased, the first power recovery capacitor and the second power recovery capacitor both being coupled to the sustain discharge electrodes.

An exemplary plasma display device according to an embodiment of the present invention includes a plurality of first electrodes, a first transistor, a second transistor, at least one inductor, a fourth power source, a third transistor, a fifth power source, and a fourth transistor. The first transistor is coupled between a first power source and the plurality of first electrodes, and the first power source supplies a first voltage above a reference voltage. The second transistor is coupled between a second power source and the plurality of first electrodes, and the second power source supplies the reference voltage. The at least one inductor has a first end coupled to the plurality of first electrodes. The fourth power source is coupled between an anode and a cathode of a third power source, and supplies a third voltage that is higher than a second voltage that corresponds to half of a voltage difference between the first voltage and the reference voltage. The third transistor is coupled between a second end of an inductor among the at least one inductor, and the fourth power source. The fifth power source is coupled between a cathode and an anode of the third power source, and supplies a fourth voltage that is lower than the second voltage. The fourth transistor is coupled between a second end of the inductor among the at least one inductor and the fifth power source.

An exemplary driving method according to another embodiment of the present invention drives a plasma display device having a plurality of first electrodes. In the driving method, a first voltage is supplied from a first power source, the first voltage being greater than a reference voltage. A second power source is provided for supplying a second voltage that is greater than half of the first voltage. A third power source is provided for supplying a third voltage that is less than half of the first voltage. A voltage to the plurality of first electrodes is increased by supplying to the first electrodes the second voltage from the second power source through an inductor coupled to the second power source. The first voltage is then applied to the plurality of first electrodes. The voltage to the plurality of first electrodes is decreased by supplying to the first electrodes the third voltage from the third power source through the inductor coupled to the second power source. The reference voltage is then applied to the plurality of the first electrodes.

### BRIEF DESCRIPTION OF THE DRAWINGS

FIG. 1 shows a plasma display device according to an exemplary embodiment of the present invention.

FIG. 2A is a circuit diagram of a scan electrode driver according to a first exemplary embodiment of the present invention.

FIG. 2B shows current paths for respective modes of a scan electrode driver according to a first exemplary embodiment of the present invention.

FIG. 3 is a circuit diagram of a scan electrode driver according to a second exemplary embodiment of the present invention.

FIG. 4 is a circuit diagram of a scan electrode driver according to a third exemplary embodiment of the present invention.

### DETAILED DESCRIPTION

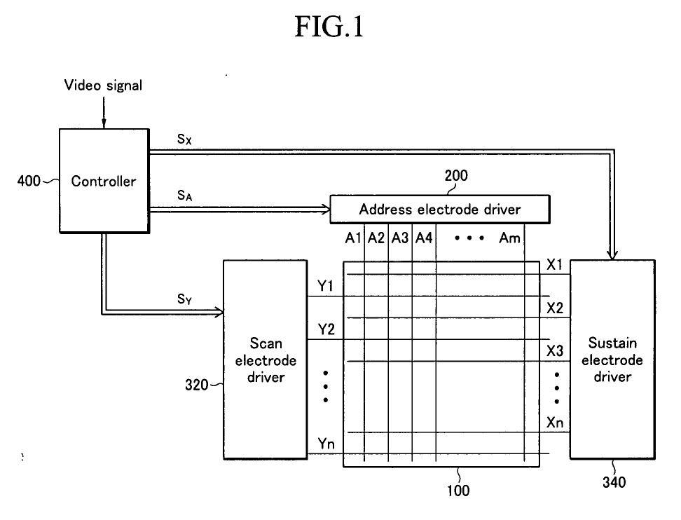

Referring to FIG. 1, a plasma display device includes a PDP 100, an address electrode driver 200, a scan electrode driver 320, a sustain electrode driver 340, and a controller 400.

The PDP 100 includes a plurality of address electrodes Al to Am extending in a column direction, and a plurality of sustain and scan electrodes Xl to Xn and Y1 to Yn extending in a row direction by pairs. Hereinafter, the address electrode is referred to as an A electrode, the sustain electrode is referred to as a Y electrode, and the scan electrode is referred to as an X electrode.

The address electrode driver 200 receives an address driving control signal SA from the controller 200, and applies a display data signal to the respective A electrodes to select a discharge cell to be displayed.

The scan electrode driver 320 and the sustain electrode driver 340 respectively receive a scan electrode driving signal Sy and a sustain electrode driving signal Sx from the controller 200, and apply driving voltages to the Y electrodes and the X electrodes, respectively.

The controller 400 externally receives a video signal, generates the address driving control signal SA, the scan electrode driving signal Sy, and the sustain electrode driving signal Sx, and transmits the signals SA, SY, SX to the address electrode driver 200, the scan electrode driver 320, and the sustain electrode driver 340, respectively.

A configuration and operation of a circuit of the scan electrode driver according to an exemplary embodiment of the present invention will now be described with reference to the accompanying drawings.

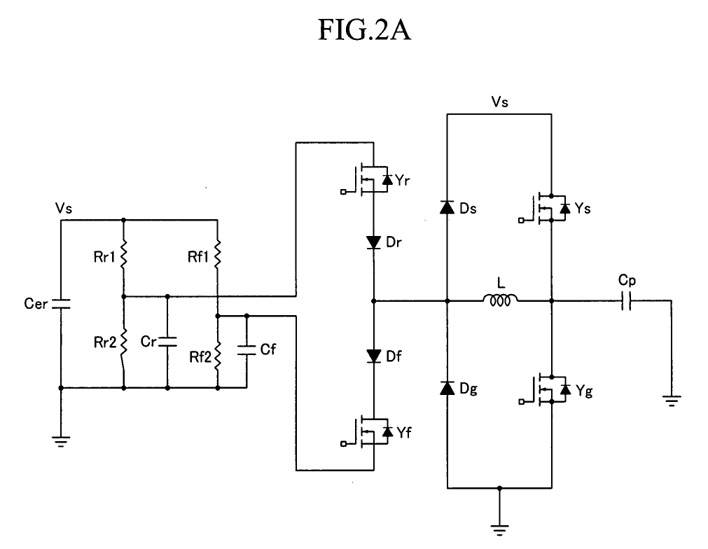

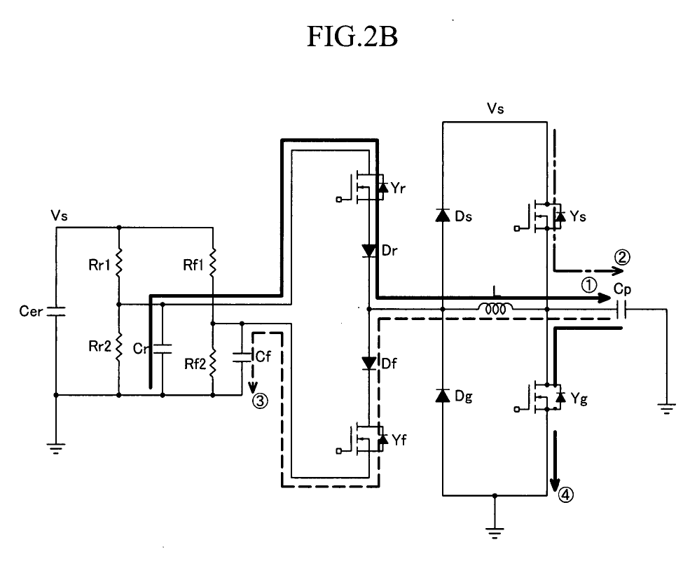

FIG. 2A is a circuit diagram of the scan electrode driver 320 according to a first exemplary embodiment of the present invention. The scan electrode driver 320 may be coupled to the plurality of Y electrodes Y1 to Yn or partially coupled to the Y electrode, in common.

As shown in FIG. 2A, the scan electrode driver 320 includes transistors Ys, Yg, and diodes Ds, Dg. The transistor Ys has a drain coupled to a Vs voltage and a source coupled to a Y electrode of a panel capacitor Cp. The transistor Yg has a drain coupled to the Y electrode and a source coupled to a ground terminal. The diode Ds is coupled between an inductor L and the Vs voltage and clamps a voltage at a first end of the inductor L to the Vs voltage. The diode Dg is coupled between the inductor L and the ground terminal and clamps the voltage at the first end of the inductor L to a ground voltage (0V in FIG. 2A). In addition, a power recovery circuit for recovering and reusing power includes the inductor L, transistors Yr, Yf, diodes Dr, Df, capacitors Cer, Cr, Cf, and resistors Rr1, Rr2, Rfl, Rf2.

The panel capacitor Cp equivalently represents capacitance components between the X electrode and the Y electrode, and, for convenience of description, an X electrode of the panel capacitor Cp is described to be coupled to the ground terminal.

A cathode of the capacitor Cer is coupled to the ground terminal, and the resistors Rr1, Rr2 and the resistors Rf1, Rf2 are coupled in parallel between an anode and a cathode of the capacitor Cer. The resistors Rr1, Rr2 are coupled in series, and the resistors Rf1, Rf2 are coupled in series. In addition, the resistor Rr2 is coupled in parallel with the capacitor Cr, and the resistor Rf2 is coupled in parallel with the capacitor Cf. The capacitor Cer is charged with the Vs voltage, and a voltage at the resistor Rr2 among voltages divided by the resistors Rr1, Rr2 is charged to the capacitor Cr and a voltage at the resistor Rf2 among voltages divided by the resistors Rfl, Rf2 is charged to the capacitor Cf. In addition, the anode of the capacitor Cer may be coupled to a power source Vs in order to maintain the voltage charged to the capacitor Cer at a level of the Vs voltage.

A drain of the transistor Yr is coupled to a node of the resistors Rr1, Rr2, and a source of the transistor Yf is coupled to a node of the resistors Rfl, Rf2. In addition, a body diode may be formed in the transistors Yr, Yf, respectively, and thus an anode of each body diode may be coupled to respective sources of the transistors Yr, Yf and a cathode of each body diode may be coupled to respective drains of the transistors Yr, Yf. The diodes Dr, Dr are coupled in a direction to block current flow through the body diode.

The respective transistors may be formed of a plurality of transistors coupled in parallel.

A time-variant operation of a driving circuit in a sustain period according to the first exemplary embodiment of the present invention will be described with reference to FIG. 2A and FIG. 2B. Herein, the time-variant operation is sequentially performed from a mode 1 (Ml) to a mode 4 (M4), and the mode can be changed from one to another by an operation of the transistor. In the following description, the term inductance-capacitance (LC) resonance is used. It should be understood that the term does not necessarily refer to the infinite behavior of oscillation. In the following description, the term LC resonance is used to specify the curve or pattern according to which the behavior of voltage will follow during an increase or a decrease thereof. A threshold voltage of a semiconductor element (a transistor or a diode) is quite low compared to a discharge voltage, and therefore, the threshold voltage is approximated to OV in the following description.

FIG. 2B shows current paths formed by the Y electrode driver in the respective modes according to the first exemplary embodiment of the present invention.

In the first exemplary embodiment, it is assumed that the capacitor Cer is charged with the Vs voltage before Ml starts. Therefore, the capacitor Cr is charged with a voltage at the resistor Rr2 among voltages divided by the resistors Rr1, Rr2. That is, a voltage Vcr at the capacitor Cr becomes VsRr2/(Rr1+Rr2).

During Ml, the transistor Yr is turned on. Then, as shown in FIG. 2B, a current path \textcircled{1} is formed through the capacitor Cr, the transistor Yr, the diode Dr, the inductor L, and the panel capacitor Cp, and accordingly, an LC resonance is generated between the inductor L and the panel capacitor Cp. Charges charged in the capacitor Cr due to the LC resonance move to the panel capacitor Cp and thus the panel capacitor Cp is charged, and the voltage of the Y electrode gradually increases from 0V.

However, the voltage of the Y electrode cannot reach the Vs voltage due to parasitic components formed in the respective elements. Therefore, the voltage charged to the capacitor Cr is set to be higher than half of the Vs voltage to thereby increase the voltage of the Y electrode almost to the Vs voltage. That is, the capacitor Cr is charged with the voltage Vcr (Vcr=VsRr2/(Rr1+Rr2)), and accordingly, VsRr2/(Rr1+Rr2)>Vs/2 should be satisfied. Therefore, the value of the resistor Rr2 is set to be greater than that of the resistor Rr1.

During M2, the transistor Yr is turned off and the transistor Ys is turned on. Then, as shown in FIG. 2B, a current path \textcircled{2} is formed through the power source Vs, the transistor Ys, and the panel capacitor Cp, and the Vs voltage supplied from the power source Vs is applied to the Y electrode of the panel capacitor Cp through the transistor Ys.

However, the voltage of the Y electrode has been increased to the Vs voltage during Ml, and accordingly, hard switching is not generated when the transistor Ys is turned on during M2.

During M3, the transistor Ys is turned off and the transistor Yf is turned on, and a current path \textcircled{3} is formed through the panel capacitor Cp, the inductor L, the diode Df, the transistor Yf, and the capacitor Cf, as shown in FIG. 2B. Accordingly, an LC resonance is generated between the inductor L and the panel capacitor Cp. The charge charged to the panel capacitor Cp moves to the capacitor Cf by the LC resonance and thus the capacitor Cf is charged, and the voltage of the Y electrode of the panel capacitor Cp is gradually decreased from the Vs voltage.

However, as previously described, the voltage of the Y electrode cannot decrease to 0V due to the parasitic components formed in the respective elements. Therefore, the voltage charged to the capacitor Cf is set to be lower than half of the Vs voltage to thereby decrease the voltage of the Y electrode almost to 0V. That is, the capacitor Cf is charged with a Vcf voltage (Vcf=VsRf2/(Rfl+Rf2)), and accordingly, VsRf2/(Rfl+Rf2)<Vs/2 should be satisfied. Therefore, the value of resistor Rf2 is set less than that of the resistor Rf 1.

During M4, the transistor Yf is turned off and the transistor Yg is turned on. Then, as shown in FIG. 2B, a current path \textcircled{4} is formed through the capacitor Cp, the transistor Yg, and the ground terminal, and accordingly, the Y electrode of the panel capacitor Cp is applied with a ground voltage.

However, the voltage of the Y electrode has been decreased to 0V during M3, and therefore, the hard switching is not generated when the transistor Yg is turned on during M4.

As described, the power recovery circuit according to the exemplary embodiment of the present invention performs a rising operation in a potential that is higher than the voltage Vs/2 and performs a falling operation in a potential that is lower than the voltage Vs/2, and therefore, the voltage of the Y electrode can be increased to the Vs voltage or decreased to 0V by the power recovery operation.

From Ml through M4, the voltage of the Y electrode can swing between 0V and the Vs voltage. In addition, operations in Ml to M4 are repeated after M4 is finished.

Further, the resistors coupled in series with the capacitor Cer are coupled in parallel, and the capacitor is coupled to one of the resistors coupled in series according to the first exemplary embodiment of the present invention. However, the respective resistors coupled in series may be coupled with respective capacitors.

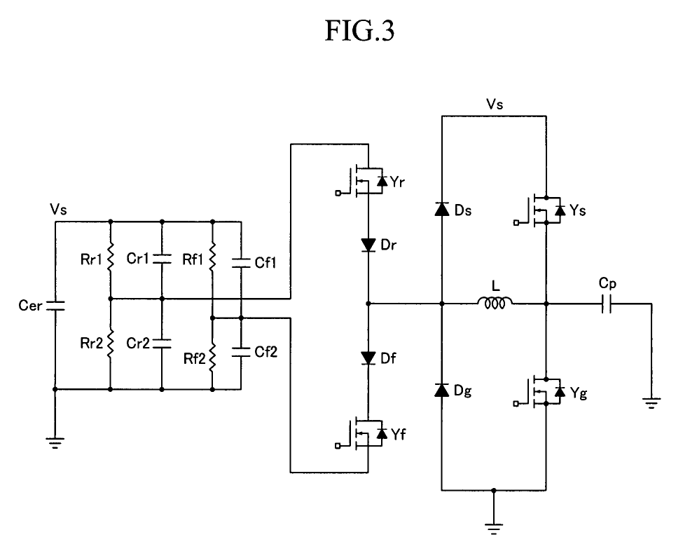

FIG. 3 is a circuit diagram of the Y electrode driver 320 according to a second exemplary embodiment of the present invention.

As shown in FIG. 3, a Y electrode driver 320 is the same as that of the first exemplary embodiment of the present invention except that the Y electrode driver 320 further includes capacitors Cr1, Cf1.

In more detail, the resistors Rr1, Rr2 that are coupled with each other in series and coupled to the capacitor Cer in parallel are respectively coupled in parallel with the capacitor Cr1 and the capacitor Cr2. Similar to the resistors Rr1, Rr2, the resistors Rf1, Rf2 that are coupled with each other in series and coupled to the capacitor Cer in parallel are coupled in parallel with the capacitors Cf1, Cf2, respectively.

In this case, similar to the first exemplary embodiment of the present invention, the voltage of the Y electrode is increased by using the charges supplied from the capacitor Cr2 during a voltage rising period of the power recovery operation and decreased by using the charges supplied from the capacitor Cf2 according to the second exemplary embodiment of the present invention.

In the second exemplary embodiment, a voltage Vcr2 charging the capacitor Cr2 becomes greater than half of the voltage Vs by setting the value of resistor Rr2 to be greater than that of the resistor Rr2, and a voltage Vcf2 charging the capacitor Cf2 becomes lower than half of the voltage Vs by setting the value of resistor Rf2 to be less than that of the resistor Rf 1.

Thus, the voltage of the Y electrode can be increased to the Vs voltage and can be decreased to 0V through the power recovery operation. Therefore, hard switching does not occur when the transistor Ys and the transistor Yg are turned on. In addition, the charge charged to the capacitor Cer is charged to the two pairs of capacitors Cr1, Cr2, and Cf1, Cf2 at the same time, and therefore, time for charging the capacitors Cr2, Cf2 can be reduced compared to the first exemplary embodiment of the present invention.

Further, a level of power during the voltage rising period and a level of power during the voltage falling period may be set to be different from each other by coupling the zener diode and the capacitor to the capacitor Cer.

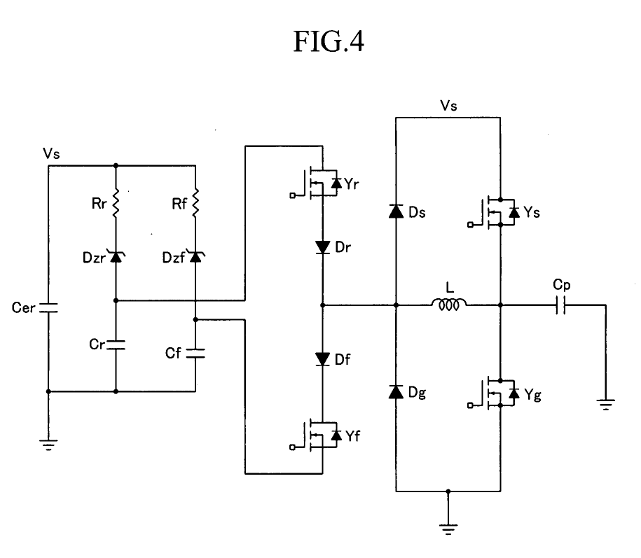

FIG. 4 is a circuit diagram of the Y electrode 320 according to a third exemplary embodiment of the present invention.

As shown in FIG. 4, a resistor Rr, a zener diode Dzr, and a capacitor Cr are coupled in series, and a resistor Rf, a zener diode Dzf, and a capacitor Cf are coupled in series. In addition, each group of the resistor, the zener diode, and the capacitor coupled in series is coupled in parallel with a capacitor Cer. The capacitor Cr operates as a power source for increasing a voltage of the Y electrode and the capacitor Cf operates as a power source for decreasing the voltage of the Y electrode during a power recovery operation.

In more detail, the capacitor Cer is charged with a Vs voltage, and therefore the capacitor Cr is charged with a (Vs−Vdzr) voltage (that is, a voltage decreased by a breakdown voltage Vdzr of the zener diode Dzr from the Vs voltage), and the capacitor Cf is charged with a (Vs−Vdzf) voltage (that is, a voltage decreased by a breakdown voltage Vdzf of the zen3r diode Dzf from the Vs voltage).

At this time, the (Vs−Vdzr) voltage is set to be greater than half of the Vs voltage, and the (Vs−Vdzf) voltage is set to be less than half of the Vs voltage. That is, the breakdown voltages of the zener diodes Dzr, Dzf are set to satisfy Vdzr<Vs/2 and Vdzf>Vs/2.

Accordingly, the voltage of the Y electrode can be increased to the Vs voltage and decreased to OV through the power recovery operation, thereby preventing an occurrence of hard switching when turning on the transistors Ys, Yg.

According to the exemplary embodiment of the present invention, the transistors Yr, Yf, Ys, Yg are provided as a NMOS transistor and thus a body diode is formed, but they can be replaced with other transistors.

In addition, the diode Dr is coupled between the transistor Yr and the inductor L and the diode Df is coupled between the transistor Yf and the inductor L according to the exemplary embodiment of the present invention, but an anode of the diode Dr may be coupled to a drain of the transistor Yr and an anode of the diode Df may be coupled to a source of the transistor Yf.

In addition, one inductor is coupled to the Y electrode and a charging path and a discharging path are alternately formed through the inductor according to the exemplary embodiment of the present invention, but two inductors may be used for separating the charging path and the discharging path. In addition, when the two inductors are used, one may be coupled between the capacitor Cr and the transistor Yr and the other may be coupled between the capacitor Cf and the transistor Yf.

In addition, the exemplary embodiment of the present invention describes the power recovery circuit of the scan electrode driver, but the above exemplary embodiment may be applied to power recovery circuits of a sustain electrode driver and an address electrode driver.

As described, a voltage of the power recovery capacitor is set to be greater than half of the sustain discharge voltage during a voltage rising period and is set to be lower than half of the sustain discharge voltage during a voltage falling period in the power recovery circuit. That is, the switch for supplying the sustain discharge voltage is turned on after the voltage of the panel capacitor is increased to the Vs voltage or decreased to 0V, to thereby prevent an inrush current from being generated when a switch is hard-switched and to thereby reduce stress on the switch.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device comprising:
a plurality of first electrodes;
a first transistor coupled between a first power source and the plurality of first electrodes, wherein the first power source supplies a first voltage above a reference voltage;
a second transistor coupled between a second power source and the plurality of first electrodes, wherein the second power source supplies the reference voltage;
at least one inductor having a first end coupled to the plurality of first electrodes;
a fourth power source coupled between an anode and a cathode of a third power source and supplying a third voltage that is higher than a second voltage, the second voltage corresponding to half of a voltage difference between the first voltage and the reference voltage;
a third transistor coupled between a second end of an inductor among the at least one inductor and the fourth power source;
a fifth power source coupled between the anode and the cathode of the third power source and supplying a fourth voltage that is lower than the second voltage; and
a fourth transistor coupled between a second end of an inductor among the at least one inductor and the fifth power source.

2. The plasma display device of claim 1,
wherein the fourth power source comprises:
a first resistor and a second resistor coupled in series between the anode and the cathode of the third power source, and
a first capacitor coupled in parallel with the second resistor and supplying the third voltage through a node of the first resistor and the second resistor, and
wherein the fifth power source comprises:
a third resistor and a fourth resistor coupled in series between the anode and the cathode of the third power source, and
a second capacitor coupled in parallel with the fourth resistor and supplying the fourth voltage through a node of the third resistor and the fourth resistor.

3. The plasma display device of claim 2, wherein the value of the second resistor is greater than that of the first resistor and the value of the fourth resistor is less than that of the third resistor.

4. The plasma display device of claim 2, wherein the fourth power source further comprises a third capacitor coupled in parallel with the first resistor, and the fifth power source further comprises a fourth capacitor coupled in parallel with the third resistor.

5. The plasma display device of claim 1,
wherein the fourth power source comprises a first zener diode and a first capacitor coupled in series between an anode and a cathode of the third power source, and supplies the third voltage through a node of the first capacitor and the first zener diode, and
wherein the fifth power source comprises a second zener diode and a second capacitor coupled in series between the anode and the cathode of the third power source, and supplies the fourth voltage through a node of the second capacitor and the second zener diode.

6. The plasma display device of claim 5, wherein a breakdown voltage of the first zener diode is less than the second voltage, and a breakdown voltage of the second zener diode is greater than the second voltage.

7. The plasma display of claim 1, wherein the third power source comprises a fifth capacitor for charging a voltage that corresponds to a voltage difference between the first voltage and the reference voltage and having a cathode coupled to the second power source.

8. The plasma display device of claim 1, further comprising:
a first diode electrically coupled between the at least one inductor and the third transistor and determining a current direction so as to charge the first electrode, and
a second diode electrically coupled between the at least one inductor and the fourth transistor and determining a current direction to discharge the first electrode.

9. The plasma display device of claim 1, wherein a voltage of the first electrode is increased by turning on the third transistor and decreased to the second voltage by turning on the fourth transistor.

10. A driving method of a plasma display device having a plurality of first electrodes, the driving method comprising:
supplying a first voltage from a first power source, the first voltage being greater than a reference voltage;
providing a second power source for supplying a second voltage that is greater than half of the first voltage;
providing a third power source for supplying a third voltage that is less than half of the first voltage;
increasing a voltage to the plurality of first electrodes by supplying to the first electrodes the second voltage from the second power source through an inductor coupled to the second power source;
applying the first voltage to the plurality of first electrodes;
decreasing the voltage to the plurality of first electrodes by supplying to the first electrodes the third voltage from the third power source through the inductor coupled to the second power source; and
applying the reference voltage to the plurality of the first electrodes.

11. The driving method of claim 10, wherein:
the second power source comprises a first capacitor having a cathode coupled to an end of the first power source,
the third power source comprises a second capacitor having a cathode coupled to an end of the first power source,
the providing a second power source comprises charging the first capacitor with charge supplied from the first power source, and
the providing a third power source comprises charging the second capacitor with charge supplied from the first power source.

12. A method for improving power recovery efficiency of a power recovery circuit coupled to sustain discharge electrodes of a plasma display panel, comprising:
setting a voltage of a first power recovery capacitor in the power recovery circuit to be greater than half of a sustain discharge voltage when a voltage of the power recovery circuit applied to the sustain discharge electrodes is increased, the first power recovery capacitor being coupled to the sustain discharge electrodes; and
setting a voltage of a second power recovery capacitor in the power recovery circuit to be lower than half of the sustain discharge voltage when the voltage of the power recovery circuit applied to the sustain discharge electrodes is decreased, the second power recovery capacitor being coupled to the sustain discharge electrodes.
